(19) United States
(12) Patent Application Publication
(10) Pub. No.: US 2024/0174546 A1
(43) Pub. Date: May 30, 2024

(54) MICROGRAVITY CRUCIBLE-CONTROLLED MANUFACTURING

(71) Applicant: DSTAR Communications, Inc., Woodland Hills, CA (US)

(72) Inventor: Dmitry Starodubov, Woodland Hills, CA (US)

(73) Assignee: DSTAR Communications, Inc., Woodland Hills, CA (US)

(21) Appl. No.: 18/431,823

(22) Filed: Feb. 2, 2024

Related U.S. Application Data
(63) Continuation-in-part of application No. 18/292,102, filed on Jan. 1, 0001.
(60) Provisional application No. 63/203,663, filed on Jul. 27, 2021.

(51) Int. Cl. C03B 37/027; C03B 37/025

(52) U.S. Cl. CPC C03B 37/02718; C03B 37/0253; C03B 2205/67

(57) ABSTRACT

Embodiments are directed to systems and methods for material processing in a low gravity environment, and an optical fiber formed in a low gravity environment. In some embodiments, the system may include a radiation-based heating element, such as a laser, to heat portions of a work volume of the system to process materials in the work volume. The system may control temperature and the temperature gradients to compensate for effects of a microgravity environment on the material during processing.

### CROSS-REFERENCE TO RELATED APPLICATIONS

This application is a continuation-in-part of U.S. Patent Application Ser. No. 18/292,102, filed Jan. 25, 2024 and entitled “MICROGRAVITY CRUCIBLE-CONTROLLED MANUFACTURING,” which is a national stage application under 35 U.S.C. § 371 of PCT International Application Serial No. PCT/US2022/038585, filed Jul. 27, 2022, and entitled “MICROGRAVITY CRUCIBLE-CONTROLLED MANUFACTURING,” which claims priority to U.S. Patent Application Ser. No. 63/203,663, filed on Jul. 27, 2021 and titled “MICROGRAVITY CRUCIBLE-CONTROLLED MANUFACTURING.” The disclosure of the prior applications are incorporated by reference herein in their entirety.

### TECHNICAL FIELD

This disclosure pertains to material processing in a range of environments, and, more specifically, to crucible-controlled manufacturing in microgravity environments.

### BACKGROUND

An optical fiber is a flexible, transparent fiber, often made of glass (silica) or plastic. Optical fibers are used to transmit light between the two ends of the fiber and have practical applications in the fields of fiber-optic communications, where they permit transmission over longer distances and at higher bandwidths (data rates) than wire cables. Optical fibers exhibit low attenuation characteristics and low electromagnetic interference, as compared to metal wires. Therefore, optical fibers can accommodate higher bandwidth, as mentioned, and/or longer transmission distances. Optical fiber has other uses, such as in laser applications, imaging applications, and lighting applications.

### BRIEF DESCRIPTION OF THE DRAWINGS

FIG. 1 is a simplified diagram of an example material processing system in accordance with embodiments of the present disclosure.

FIG. 2 is a diagram of an example apparatus for material processing with work volume purge in low gravity in accordance with embodiments of the present disclosure.

FIG. 3 is a diagram of an example thermal processing system with gradient control along the work volume for controlling the neck-down region during the fabrication of the optical fiber in low gravity environment in accordance with embodiments of the present disclosure.

FIG. 4 is a flow diagram for operation of an optical fiber drawing apparatus in accordance with embodiments of the present disclosure.

FIG. 5 is a diagram of an example fiber draw process with a uniform heat distribution in a low gravity environment.

FIG. 6 is a diagram of an example fiber draw process with a non-uniform heat distribution in a low gravity environment in accordance with embodiments herein.

FIG. 7 is a diagram of an example fiber draw process with gradient-controlled heat distribution in a low gravity environment in accordance with embodiments herein.

FIG. 8 illustrates another example material processing system in accordance with embodiments of the present disclosure.

### DETAILED DESCRIPTION

Industrial methods of material processing, such as melting, crystal formation, extrusion, and fiber draw often depend on increasing the temperature of the materials and maintaining certain the certain temperature variations (gradients) to achieve the desired transformations of material properties. The material processing in microgravity environment and in space is different from established processing methods on Earth in normal gravity environments. The thermal convection and the convection heat transfer are suppressed in the absence of gravity. As a result, the existing material processing methods and systems from the ground cannot be directly used in space. One of the challenges for material processing in microgravity environment is the control of the temperature gradients. Aspects herein deliver a solution for establishing and maintaining the optimal temperatures, temperature gradients and specifically maintaining the optimal thermal parameters for optical fiber manufacturing in microgravity environment.

Certain aspects of the present disclosure are directed to a system for processing materials in low gravity environments, e.g., for making optical fibers in low gravity environments, such as aboard space-borne vehicles or platforms. In this disclosure, the terms “low gravity environments” or “microgravity environments” may refer to environments with gravitational forces of g≤10-2 G for two or more minutes. For example, a low/microgravity environment can include a space-borne vehicle/platform, such as the International Space Station (ISS), other orbital platforms, or orbital vehicles.

In certain embodiments, for example, a manufacturing system may maintain an optimal temperature distribution in a work volume for processing of materials in low gravity environments. In some embodiments, the system uses heating that is varied along the work volume in combination with the distributed conductive cooling. Thermal sensors along the work volume can be used to record the temperature distribution along the work volume. The optimal temperature distribution may be recorded on the ground and then reproduced in microgravity environments using distributed heating and conductive cooling of the work volume. In the optical fiber draw process, the transformation cone where the glass preform is turning into optical fiber is called a “neck-down region”. The control of the temperature gradient along a crucible as described herein can enable the control of the shape and the position of the neck-down region, which can provide a steady fiber draw process with consistent fiber properties.

The techniques described herein can be used for material processing, e.g., optical fiber manufacturing, in low gravity environments, such as aboard space-borne vehicles or platforms. For instance, certain embodiments are directed to a crucible for forming optical fibers or other products with heating elements to provide particular temperature distributions along the length of the crucible, which can allow for improved neck-down regions in optical fiber draw processes in low gravity environments.

Embodiments herein can be used for manufacturing optical fibers that can achieve the insertion loss in the infrared spectrum of less than 0.12 dB/km. For instance, optical fibers made from glasses with low insertion loss in infrared spectral range, such as fluoride-based optical fibers, including Indium Fluoride and ZBLAN (ZrF4-BaF2-LaF3-AlF3-NaF), can be manufactured that approach the theoretical limit of insertion loss of 0.14 dB/km or 140 dB per 1000 km, with actual insertion loss under 200 dB per 1000 km. ZBLAN optical fibers have been characterized as having a theoretical minimum insertion loss of 10-30 dB per 1000 km. ZBLAN optical fibers, however, can undergo errant crystallization and detrimental phase separation during fabrication, and these factors of crystallization and phase separation can inhibit reaching the theoretically low loss. These crystallization and phase separation phenomena are suppressed in low gravity environments.

Optical crystals such as AgCl and AgBr (silver chloride and silver bromide, respectively) and crystalline optical fibers, such as fibers described in U.S. Pat. No. 5,309,543, incorporated here by the reference, can benefit from the processing methods described herein. The benefits include reduction of insertion loss, reduction of scattering and better uniformity. Additional benefits of microgravity processing using aspects herein include zone melting of processed materials. Zone melting is group of techniques for purifying an element or a compound or control its composition by melting a short region (i.e., zone) and causing this liquid zone to travel slowly through a relatively long ingot, or charge, of the solid. As the zone travels, it redistributes impurities along the charge. Zone melting processes and materials are known in the art, and the use of zone melting with the techniques herein may allow for improvements in the purity of the glass preforms and crystal materials. The crystals and fiber preforms could be placed inside an ampoule container made out of glass or inert metal during the processing. This container could be sealed during the zone melting purification process. The container could be opened for further processing steps, e.g., those of the present disclosure, after the completion of zone purification.

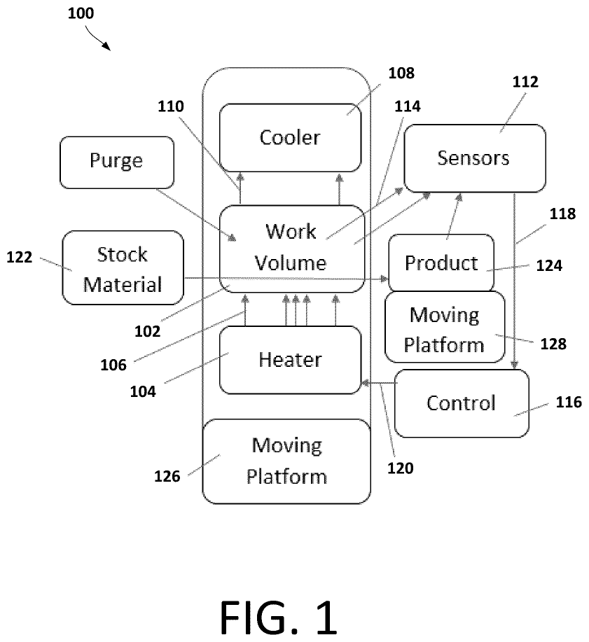

FIG. 1 is a simplified diagram of an example material processing system 100 in accordance with embodiments of the present disclosure. The system 100 includes a work volume 102 that can be used to transform materials, e.g., as described herein. For example, the work volume 102 can be a cylindrical-shaped oven/heater that is used to apply heat to a preform and soften the preform, e.g., to draw optical fiber from a fiber preform. As another example, the work volume 102 may be used to transform certain properties of the preform, e.g., with a crystal preform wherein the work volume 102 provides an area for de-crystallization and/or re-crystallization or provides an area in which defects or impurities are removed from the crystal preform.

The work volume 102 is heated by a heat source, heater 104. The heat delivery 106 to the work volume 102 is distributed along the length of the work volume 102 with a pattern that is optimized for material processing in low gravity environments. In low (e.g., microgravity) environments, the lack of convection cooling results in uniform temperature distribution along the heater 104. This uniform temperature distribution can negatively affect some material processing techniques, such as fiber drawing, which depend on gradients of temperature distribution. In the case of an optical fiber draw, the fiber neck-down region becomes short, moves to the edge of the heater, and the draw process becomes unstable.

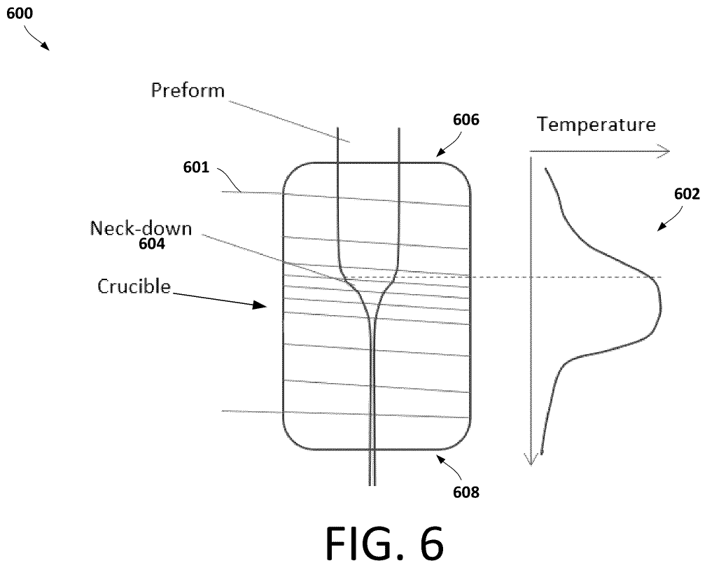

To avoid these or other issues, the system 100 includes a cooler 108 to establish a gradient of temperature. The cooling means 110 are distributed along the work volume 102 in order to reach the desired cooling distribution. One way of achieving the cooling is through thermal conductivity. In certain embodiments, supporting elements of the crucible, such as a wire harness, could be used for cooling the crucible. In one example, cooling is achieved through mounting wire elements on each end of the crucible, and the winding of the heating element is apodized to have denser spacing in the center of the crucible. That is, in certain instances, the distribution of the winding density (the number of windings per unit length) along the length of the crucible is similar to a higher toward the center of the crucible and lower at the ends of the crucible. In some instances, the winding density may be similar to a Gaussian distribution, which can cause a similar temperature distribution along the length of the crucible (e.g., the winding and temperature distribution may be similar to the temperature distribution 602 shown in FIG. 6).

The system 100 also includes a sensor system 112 that has distribution of sensors 114 along the work volume 102 to measure the temperature distribution. The system 100 also includes a control system 116 that receives sensor input(s) 118 from the sensor system 112 and provides the control signals 120 to the heater 104 to achieve a desired temperature distribution. In the system 100, a stock material 122 is moved through the work volume 102 and transformed into product 124 at the output. In certain embodiments, the heater, work volume, and cooler could be all placed on a moving platform 126, such as linear translation stage. The product 124 can be placed on a moving platform 128, such as rotating fiber spool. The control signals 120 to the heater element from the control system 116 may be faster than the cooling rate 110 in certain embodiments. For instance, an example of slow and inadequate control is the standard temperature controller with switching relay, which may turn off the heater when reaching a desired temperature. This can result in reaching a flatter temperature distribution, which shifts the neck-down region and results in variations of the fiber diameter. An example of an adequately fast control system is a fast-switching power supply with electronic control of the output (120) that establishes asymptotic approach of the working temperature to a desired value.

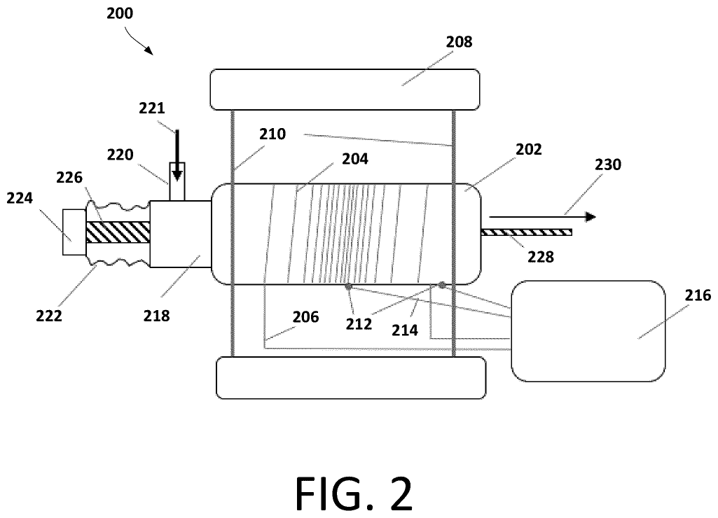

FIG. 2 is a diagram of an example system 200 for material processing with work volume purge in low gravity in accordance with embodiments of the present disclosure. The system 200 includes a non-uniform (e.g., apodized) heater winding 204 that is activated by a power supply 206. The system 200 includes a supporting structure 208 that can be used for conductive cooling of the crucible using a wire harness 210. Temperature sensors (e.g., 212) are connected through delivery means 214 to a control unit 216. The entering side of the work volume 202 (the left side of the system 200 in FIG. 2) is connected to a coupling element 218 that has a purge delivery port 220. The purge 221 delivered via the port 220 could be a dry inert gas, such as argon or nitrogen, in certain embodiments. The system 200 also includes a flexible pouch 222 that can be used to seal the space between the preform mount 224 and the coupling element 218 to ensure environmental protection of the preform 226 that is transformed into a fiber 228 at the output of the work volume 202. The direction 230 shows a direction of a gas purge 221 that is output as well as the direction of the fiber draw. The pouch 222 could be used for protecting the preform 226 before the start of the processing and until its installation into the system 200. Such protection could be established by the means of vacuum seal of the pouch 222 around preform 226. The installation of the preform and filling up of the pouch through the port 220 may establish the unobstructed moving of the preform 226 through the work volume 202 without exposure of the preform to the environment outside the work volume. In certain configurations the cooling of the work volume 202 could be achieved by using the flow of gas purge 221 in addition to (or instead of) the conductive cooling through elements 210.

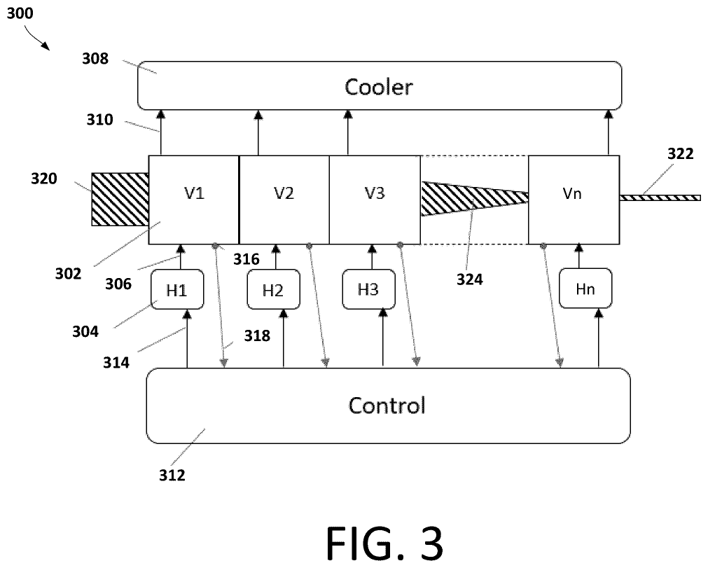

FIG. 3 diagram of an example thermal processing system 300 with gradient control along the work volume for controlling the neck-down region during the fabrication of the optical fiber in low gravity environment in accordance with embodiments of the present disclosure. The system 300 includes a number n of 302 work volumes 302 (V1 . . . Vn). Each work volume 302 is activated by a respective heater 304 (H1 . . . Hn) via heat delivery means 306. A cooling support 308 is conductively connected to each of the work volumes 302 using supports 310. A control unit 312 delivers control power to the heaters 304 using power delivery means 314. Each work volume has a sensor element 316 coupled thereto, and each sensor element 316 delivers one or more parameters of its corresponding work volume using delivery means 318. Examples of sensors 316 includes temperature sensors, fiber diameter sensors, or any other suitable process control sensors. A preform 320 is fed into the work volumes 302, from the left side of FIG. 3. In certain embodiments, the feeding mechanism may be moving the combination of work volumes, heaters, cooler and sensors towards a stationary preform. The properties of the output fiber 322 may be controlled through the preform neck-down region 324 by optimizing the heating controls for the working volumes 302.

The example systems described above can be used for manufacturing items, e.g., optical fiber, in low gravity environments, such as on orbital platforms/stations such as the International Space Station. The systems can include one or more supports that provide structural integrity and can include one or more mounts for attaching the systems to the orbital platform during operation in space. The supports/mounts can include materials that damp/reduce vibrations from the platform. In addition, the systems can include a shield that provides isolation from the space environment during operation and rocket environment during the preparation for launch and during trip on a rocket to space. For instance, the shield may be used to create a low-pressure environment, or may be used to create a shielded environment with a gas fill (e.g., a formic gas with hydrogen content), without oxygen (e.g., to prevent oxidation), chlorine gas (e.g., to suppress water related reactions), or a dry environment without water vapor.

The systems described above can also include additional components than those shown or described. For instance, the systems may additionally include preform holders that hold the preforms in place during operation, alignment elements that align a position of the preform and/or the resulting object/optical fiber, or additional sensors not described above (e.g., cameras, tension sensors, etc.). Further, the systems can include one or more mechanisms for feeding the preforms at a particular rate into the work volumes and one or more mechanisms for physically pulling/feeding the object through the work volumes. As an example, the systems may include one or more collecting elements (e.g., spools) for collecting the transformed material (e.g., optical fiber). As another example, the systems may include a motor for moving the preform through a stationary work volume, for moving the work volume across the preform, or both. The systems can also include controllers for such mechanisms (e.g., controllers for the speed of the example motors described), which can use information from one or more sensors of the system to provide control signals.

The preforms described above can be a multicomponent glass such as fluoride glass composition, e.g., ZBLAN glass with a composition ZrF4-BaF2-LaF3-AlF3-NaF. In some instance, the preforms can be coated with a protective material such as fluoride polymer, e.g., Teflon. In other embodiments, the preforms can be a crystal material, e.g., gallium nitride or silicon carbide crystals.

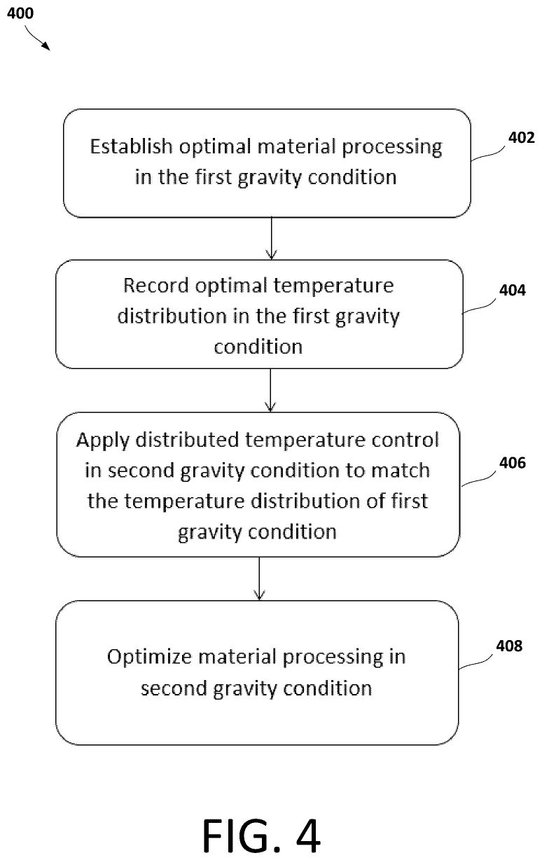

FIG. 4 is a flow diagram 400 for operation of an optical fiber drawing apparatus in accordance with embodiments of the present disclosure. The flow diagram 400 describes a method of establishing the optimal fiber manufacturing parameters in microgravity environment. The flow of FIG. 4 may include additional, fewer, or different operations than those shown. In some instances, certain operations of the flow may be performed by sub-operations. The flow begins at 402, where an optimal material processing in a first gravity environment is established. This may include optimizing the process in a known gravity condition using a system of the present disclosure. For example, the process may be optimized using one of the systems shown in FIGS. 2-3 at a normal (1 g) gravity on the ground (on Earth). At 404, an optimal temperature distribution is recorded into a control unit for the first gravity condition. Later, the system on which the optimal processing conditions were established at 402 is delivered to a second gravity environment, e.g., a low gravity environment. At 406, after delivery of the system to the second gravity environment, a distributed temperature control is applied to match the optimal temperature distribution recorded at 404 from the optimized process from 402. Finally, at 408, e.g., upon establishing the processing conditions for the first environment (e.g., ground), the process may be further optimized for the second (e.g., microgravity) environment.

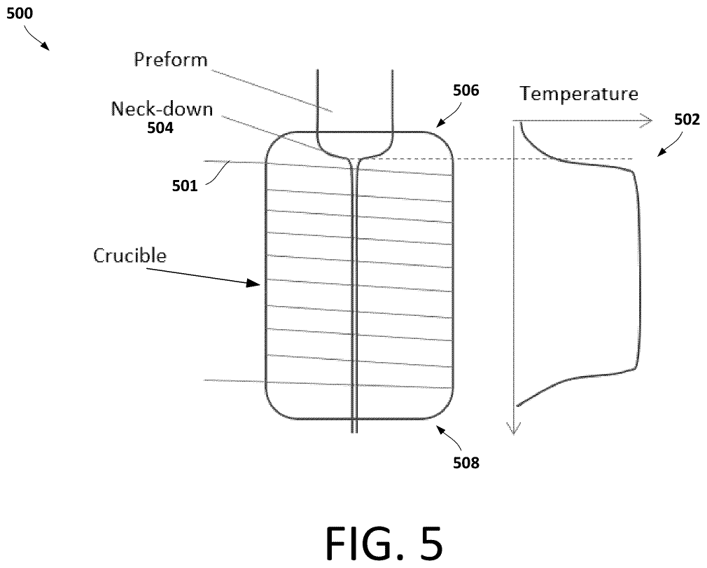

FIG. 5 is a diagram of an example fiber draw process 500 with a uniform heat distribution in a low gravity environment. In particular, the example process shown in FIG. 5 may be representative of the performance of a typical ground-designed crucible with a uniform winding when used in microgravity environment. In the example shown, there is a uniform heater winding 501 along the length of the crucible. On ground, due to convection, such a winding would produce an approximately Gaussian temperature distribution along the length of the crucible, which would provide a neck-down region 504 that is considered optimal. However, as shown, the uniform heater winding provides a flat temperature distribution 502 along the length of the crucible (as shown on the right side of FIG. 5) when used in a low gravity environment. The flat temperature distribution causes the neck-down region 504 to be moved/pushed toward the input side 506 of the crucible (away from the output side 508). The resulting short neck-down can become unstable and may result in variations of fiber diameter as well as poor resultant fiber quality.

FIG. 6 is a diagram of an example fiber draw process with a non-uniform heat distribution in a low gravity environment in accordance with embodiments herein. In particular, the example process shown in FIG. 6 may be representative of a crucible of the present disclosure with passive control of the temperature gradient. In some instances, the system 200 of FIG. 2 may be used to provide the fiber draw process shown in FIG. 6. In the example shown, a non-uniform (e.g., apodized) heater winding 601 provides a non-uniform temperature distribution 602 along the length of the crucible. The non-uniform heater winding (along with cooling of the crucible ends 606, 608, e.g., via conductive cooling as described with respect to FIG. 4) results in a more ideal and reproducible shape and position of the neck-down region 604 as shown.

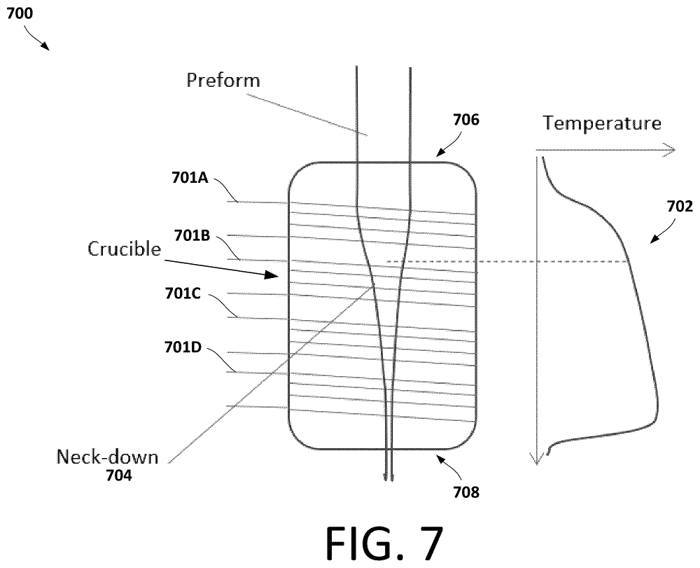

FIG. 7 is a diagram of an example fiber draw process with gradient-controlled heat distribution in a low gravity environment in accordance with embodiments herein. In particular, the example process shown in FIG. 7 may be representative of a crucible of the present disclosure with active temperature gradient control. In some instance, the system 300 of FIG. 3 may be used to provide the fiber draw process shown in FIG. 7. In the example shown, a plurality of heater windings 701 are provided along the length of the crucible, with each of the heater windings 701 being independently controlled to provide a temperature distribution, e.g., the distribution 702 shown, or a distribution similar to the distribution 602 of FIG. 6. Such control of the temperature distribution along the length of the crucible allows for control of the position and the shape of the neck-down region 704. Typically, a temperature distribution such as the distribution 702 can only be implemented in larger ovens; however, embodiments herein (e.g., the system 300 of FIG. 3) can enable such temperature distributions in smaller crucibles, allowing for more scalable manufacturing of optical fibers or other products.

Embodiments of the present disclosure can be used for other challenging material processing tasks such as crystal growth, material purification using zone melting process both on the ground (normal gravity) and in space. In addition, embodiments herein allow for implementing optimal processing conditions in microgravity environment with suppressed convection. The methods and the systems of the present disclosure may also be applicable to vacuum processing (or vacuum and microgravity combined) where the convection is also suppressed.

An example embodiment can include a system for material processing in a low gravity environment with controlled temperature gradient, the system comprising a work volume for material processing; a heating element that provides heat distribution along the work volume; a control, that controls the heat distribution pattern along the work volume, a conductive cooling means for the work volume.

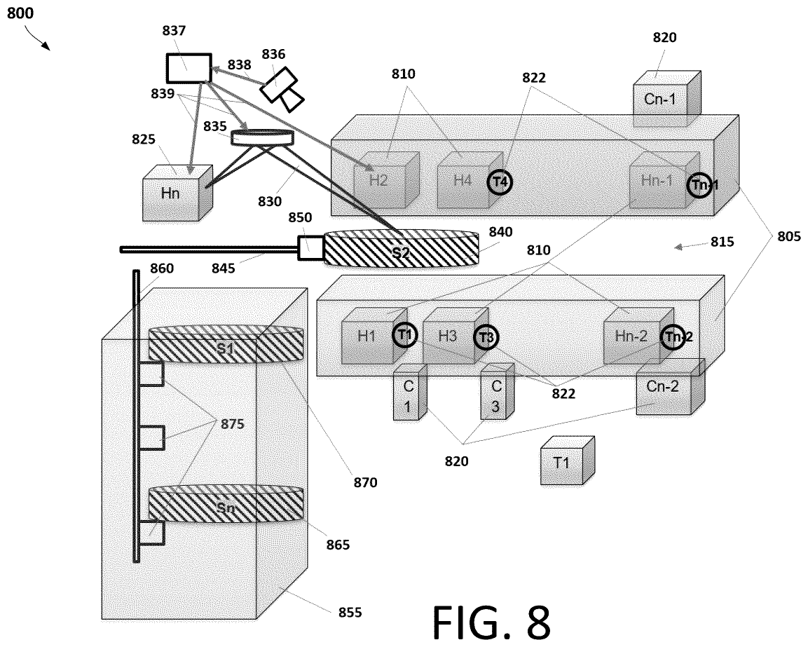

FIG. 8 illustrates another example material processing system 800 in accordance with embodiments of the present disclosure. In certain embodiments, the system 800 may be a remotely-operated system, and may be used, for example, for remote manufacturing of advanced materials in microgravity environments. As another example, the system 800 may be used for processing challenging and/or hazardous materials in non-microgravity environments, e.g., on Earth. For example, the system 800 could be used for remotely controlled optical fiber manufacturing and semiconductor wafer processing in a vacuum chamber on Earth.

The system 800 includes a crucible assembly 805 with multiple heating elements 810 that are arranged to provide controlled heating of the work volume 815 defined by the assembly 805. The crucible assembly 805 (and other embodiments of the present disclosure) can be implemented in various shapes or forms that provide optimal processing conditions in the work volume 815. As an example, in some embodiments, the assembly 805 may be implemented as a single monolithic element, while in other embodiments, the assembly 805 may be implemented as multiple elements, which may serve to better control processing in the work volume 815. In some embodiments, the assembly 805 may be implemented in a form of a tube, while in other embodiments, the assembly 805 may be implemented in a form of a planar, box-shaped heating element. In some embodiments, the assembly 805 may include two planar heating elements arranged with a work volume 815 between them, e.g., as shown in FIG. 8. A planar configuration, such as the one shown, may enable access to the work volume 815 from the sides of the crucible assembly, e.g., for the monitoring of the material or for additional control of the processing.

The system 800 further includes cooling elements 820 arranged in such a way that enables temperature gradient control across the assembly 805 (e.g., across the work volume 815). Specifically, in some embodiments, the cooling elements 820 may control the temperature gradient via forced cooling of the portions of the assembly 805 adjacent to the cooling elements 820. The assembly 805 may include any suitable number of cooling elements 820 as may be needed to control the temperature gradient, and the number may be based on a desired granularity of the temperature gradient control. The assembly 805 further includes temperature sensors 822 that measure temperatures proximate to the sensors, which data can be used to estimate the temperature distribution and thus, the temperature gradients for the assembly.

The system 800 further includes an additional heating element 825 that can be set for remotely addressing different locations in the work volume 815. The heating element 825 could be a source of radiation energy (a radiation-based energy source), such as, for example, a laser. The radiation energy source could be a single source or a combination of multiple radiation sources. For example, the radiation energy source of the heating element 825 could be a semiconductor laser, solid state laser, fiber laser, gas laser, another type of laser, or a combination of these or other lasers. The power, beam shape, and/or the modulation of the lasers of the source could be controlled (e.g., independently) to achieve the optimal processing conditions inside the work volume 815.

In some embodiments, the heating element 825 or energy from the element 825 may be moved relative to work volume 815, e.g., via automation or remote control. Alternatively, radiative energy 830 from the heating element 825 may be delivered to different regions of the work volume 815 using a scanning element 835. The scanning element 835 could be, for example, a scanning optical mirror or combination of scanning mirrors, such as galvo scanner.

Remote sensing of the work volume 815 may be performed using a sensing unit 836. The sensing unit 836 may be a non-contact sensing element, and may be or include, for example, a pyrometer, a spectrometer, an imaging sensor, a video camera, a thermal imaging camera, another type of sensing element, or a combination of these or other sensing elements.

The system 800 also includes a control unit 837 that can receive and process information from the sensing unit 836 to control (e.g., adjust) the scanning element 835, heating elements 810, 825 or other components of the system 800 to provide a particular outcome of material processing by the system 800. The control unit 837 may include a computer system (comprising one or more processors and memory) executing a software program that analyzes the signals (e.g., 838) from the sensing unit and generates control signals (e.g., 839) for the scanning element 835, heating elements 810, 825 or other components of the system 800.

The use of the feedback control loop as described allow for identification of optimal processing conditions for the system 800 on Earth (or another environment with gravity) and then reproduce these optimal processing conditions in a microgravity environment. Further, laser-assisted processing of materials in microgravity enables to safely reach high processing temperatures and high temperature gradients with high repeatability and reproducibility for sustainable remote operation in space or other microgravity environments.

In embodiments of the present disclosure, a material 840 may be placed in the work volume 815 for processing. The material 840 could come in a variety of compositions, shapes, or forms; for example, the material 840 may be a glass preform, crystal rod, or semiconductor wafer. An actuator 845 of the system 800 can move the material 840 into the work volume 815 (e.g., by pushing the material 840 as shown or in another manner). A holder 850 attached to the actuator 845 can be used to hold the material 840 in the work volume 815. The material may be processed in the work volume 815, for example, by melting, vitrification, crystallization, doping re-distribution, annealing, or zone refining the material.

The system 800 may also include a material container 855 that is in a working proximity to the work volume 815 as shown. The material container 855 may house additional material (e.g., 865, 870) as shown. An actuator 860 may be used to remove unprocessed material 865 (which may be the same as, similar to, or different from the material 840) from the container 855 for processing in the work volume 815, and/or move already-processed material 870 back into the container 855 after the processing is complete. The container 855 may also include sample holders 875 that can be used to hold the material samples (e.g., 865, 870) inside the container 855.

The system 800 may implement one or more of the aspects described above with respect to FIGS. 1-7. For example, the system 800 may be configured to provide a non-uniform temperature distribution across the work volume, e.g., a Gaussian temperature distribution as described above to process a preform to yield optical fiber. The system 800 may also be configured to provide any other suitable temperature distribution across the work volume, or to process other types of materials.

1. A system comprising:
an assembly defining a work volume for material processing;
one or more heating elements arranged to generate heat in the work volume, the heating elements comprising a radiation-based energy source; and
controller circuitry to control the one or more heating elements to provide a non-uniform heat distribution along a length of the work volume.

2. The system of claim 1, wherein the radiation-based energy source includes one or more lasers.

3. The system of claim 2, wherein the one or more lasers comprise one of a semiconductor laser, a solid state laser, a fiber laser, and a gas laser.

4. The system of claim 1, further comprising a scanning element to direct radiation generated by the radiation-based energy source into the work volume, wherein the controller circuitry is to control the scanning element.

5. The system of claim 4, wherein the scanning element comprises one or more scanning optical mirrors.

6. The system of claim 1, wherein the radiation-based energy source is separate from the assembly.

7. The system of claim 1, wherein the one or more heating elements comprise a set of heating elements coupled to the assembly.

8. The system of claim 1, further comprising one or more cooling elements arranged to cool at least a portion of the work volume.

9. The system of claim 1, further comprising a remote sensing unit separate from the assembly, the remote sensing unit coupled to the controller circuitry to provide sensing data to the controller circuitry.

10. The system of claim 9, wherein the remote sensing unit comprises one of a pyrometer, a spectrometer, an imaging sensor, a video camera, and a thermal imaging camera.

11. The system of claim 1, further comprising one or more temperature sensors inside the work volume, the temperature sensors coupled to the controller circuitry to provide temperature data to the controller circuitry.

12. The system of claim 1, further comprising an actuator to move a material through the work volume.

13. A method of material processing comprising:
applying a non-uniform heat distribution along a length of a work volume using a set of heating elements comprising at least one radiation-based energy source; and
moving a preform material through the work volume to yield an optical fiber.

14. The method of claim 13, wherein applying the non-uniform heat distribution comprises using a scanning element to direct radiation generated by the radiation-based energy source into the work volume.

15. The method of claim 14, wherein the radiation-based energy source is a laser and the scanning element includes one or more scanning optical mirrors.

16. The method of claim 13, wherein applying the non-uniform heat distribution comprises controlling a plurality of heating elements, the plurality of heating elements including the radiation-based energy source.

17. The method of claim 16, wherein applying the non-uniform heat distribution further comprises receiving information from a remote sensing unit outside the work volume, wherein the controlling is based on the information from the remote sensing unit.

18. A system comprising:
an assembly defining a work volume for material processing;
means for providing a providing a non-uniform temperature distribution along a length of the work volume, the means comprising at least one radiation-based energy source.

19. The system of claim 18, wherein the means comprises a laser.

20. The system of claim 18, wherein the means comprises a scanning element to direct energy radiated by the at least one radiation-based energy source into the work volume.
